(19) United States
(12) Patent Application Publication
(10) Pub. No.: US 2025/0217455 A1
(43) Pub. Date: Jul. 3, 2025

(54) METHODS AND SYSTEMS FOR ATTRIBUTE BASED GROUP ACCESS CONTROL

(71) Applicant: Virtru Corporation, Washington, DC (US)

(72) Inventors: William Rodgers Ackerly, Washington, DC (US); Timothy Robert Tschampel, Reston, VA (US); Timothy Allen Dumm, San Francisco, CA (US)

(21) Appl. No.: 19/004,693

(22) Filed: Dec. 30, 2024

Related U.S. Application Data
(60) Provisional application No. 63/616,850, filed on Jan. 2, 2024.

(51) Int. Cl. G06F 21/10; G06F 21/60

(52) U.S. Cl. CPC G06F 21/1015; G06F 21/604

(57) ABSTRACT

A method for attribute based group access control includes receiving, by a data event monitor of an access control management system, a notification identifying a data object uploaded to a data store. The method includes analyzing, by the data event monitor, at least one characteristic of the data object, wherein analyzing further comprises analyzing metadata associated with the data object. The method includes generating, by a data analysis engine of the access control management system, based upon the analyzing, at least one attribute-based access control rule. The method includes associating, by an access group generator of the access control management system, a group identifier with the data object, the group identifier specifying a type of user satisfying the at least one attribute-based access control rule.

### CROSS-REFERENCE TO RELATED APPLICATIONS

This application claims priority from U.S. Provisional Patent Application No. 63/616,850, filed on Jan. 2, 2024, entitled “Methods and Systems for Attribute Based Group Access Control,” which is hereby incorporated by reference.

### BACKGROUND

The disclosure relates to restricting data access. More particularly, the methods and systems described herein relate to restricting data to a set of users having at least one common attribute or accessing the restricted data from machines having the at least one common attribute.

Typically, digital rights management systems authenticate user identity in determining whether to allow a user to access data. However, in some instances, data owners may also or alternatively be concerned with a type of computing environment from which one or more users access the data. As one example, in multi-party agreements to share data, parties to the agreement may have requirements regarding the security of the hardware storing the shared data or of processes executing on the hardware and accessing the shared data.

It would be desirable to provide a system that provides functionality for allowing data owners to dynamically grant access to sets of users based on attributes of the users or of machines used to access the data.

### SUMMARY

In one aspect, a method includes receiving, by a data event monitor of an access control management system, a notification identifying a data object uploaded to a data store. The method includes analyzing, by the data event monitor, at least one characteristic of the data object, wherein analyzing further comprises analyzing metadata associated with the data object. The method includes generating, by a data analysis engine of the access control management system, based upon the analyzing, at least one attribute-based access control rule. The method includes associating, by an access group generator of the access control management system, a group identifier with the data object, the group identifier specifying a type of user satisfying the at least one attribute-based access control rule.

### BRIEF DESCRIPTION OF THE DRAWINGS

Certain objects, aspects, features, and advantages of the disclosure will become more apparent and better understood by referring to the following description taken in conjunction with the accompanying drawings, in which:

FIG. 1 is a block diagram depicting an embodiment of a system for attribute based group access control;

FIG. 2A is a flow diagram depicting an embodiment of a method for attribute based group access control;

FIG. 2B is a flow diagram depicting an embodiment of a method for attribute based group access control; and

FIGS. 3A-3D are block diagrams depicting embodiments of computers useful in connection with the methods and systems described herein.

### DETAILED DESCRIPTION

In one embodiment, the methods and systems described herein provide functionality allowing a data owner to specify attributes required of users or of machines that may access a data object; for example, the functionality may automatically and dynamically generate attribute based access groups (ABAG) that provide real-time generation of groups of users that are authorized to access data objects based on attributes of the users or of the computing devices of the users. The methods and systems described herein may provide functionality allowing transparent attribute based access control (ABAC) for role based access control. The methods and systems described herein may provide functionality allowing transparent attribute based access control for group based access control. The methods and systems described herein may execute an ABAG bridge to generate ABAGs and provide authorized users with access to data objects.

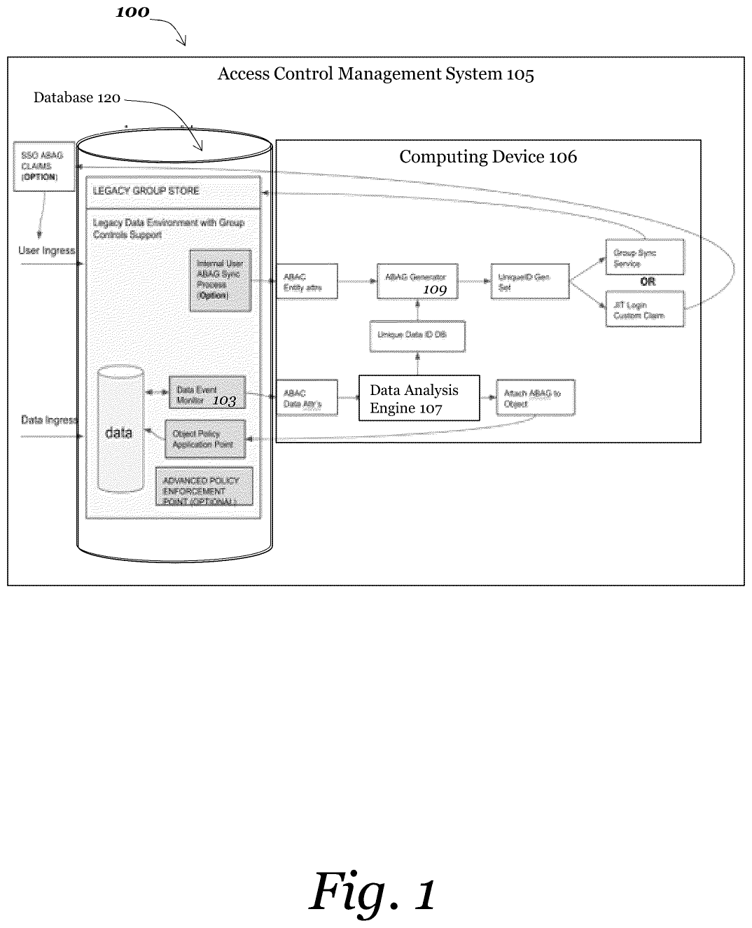

Referring now to FIG. 1, a block diagram depicts one embodiment of a system for attribute based group access control. The system 100 includes a data event monitor 103 an access control management system 105, a computing device 106, a data analysis engine 107, an access group generator 109, and a database 120.

The access control management system 105 may include the database 120 and the computing device 106. The access control management system 105 may execute functionality for providing just-in-time (JIT) custom claims to a user on entity authentication

The data event monitor 103 may be provided as a software component. The data event monitor 103 may be provided as a hardware component. The database 120 may execute the data event monitor 103. The database 120 may be in communication with the data event monitor 103. The computing device 106 may execute the data event monitor 103. A separate computing device 106b (not shown) may execute the data event monitor 103. The data event monitor 103 may be provided as a software plug-in to the database 120. The data event monitor 103 may execute functionality for intercepting data related to events (e.g., requests) to the database 120. The data event monitor 103 may execute functionality for analyzing intercepted data. The data event monitor 103 may execute functionality for transmitting data to the data analysis engine 107. The data event monitor 103 may upon an initial execution modify a role inheritance feature of the database 120 to provide item-level permissions and remove all existing individuals and groups from an existing access list before initiating the process of creating new groups for the data objects in the database 120 as described below. The data event monitor 103 may execute functionality for encoding or encrypting documents as trusted data format (TDF) documents. The data event monitor 103 may execute functionality for decrypting data objects using, e.g., privileged NPE tokens. The data event monitor 103 may execute functionality for converting user-defined tags into attributes. The data event monitor 103 may execute functionality for assigning users to groups and setting permissions.

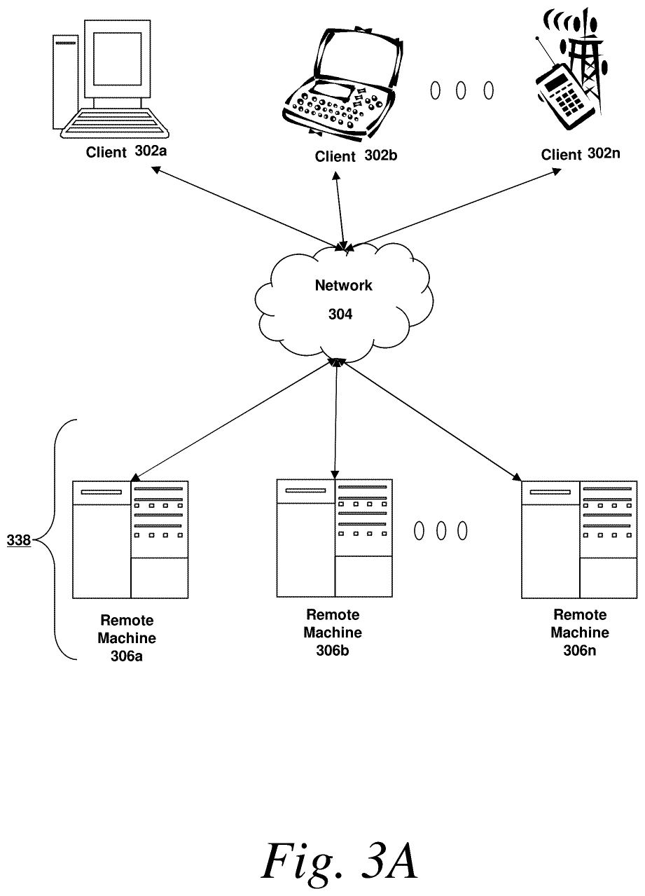

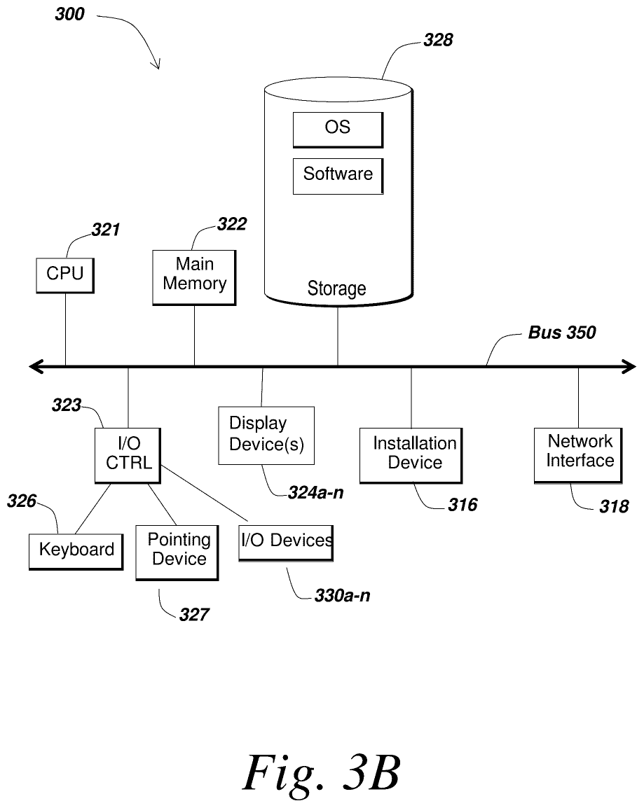

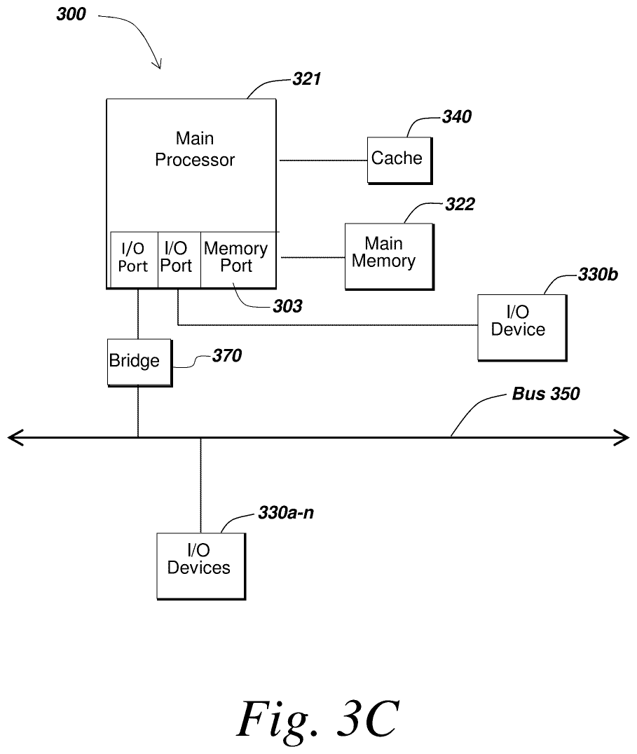

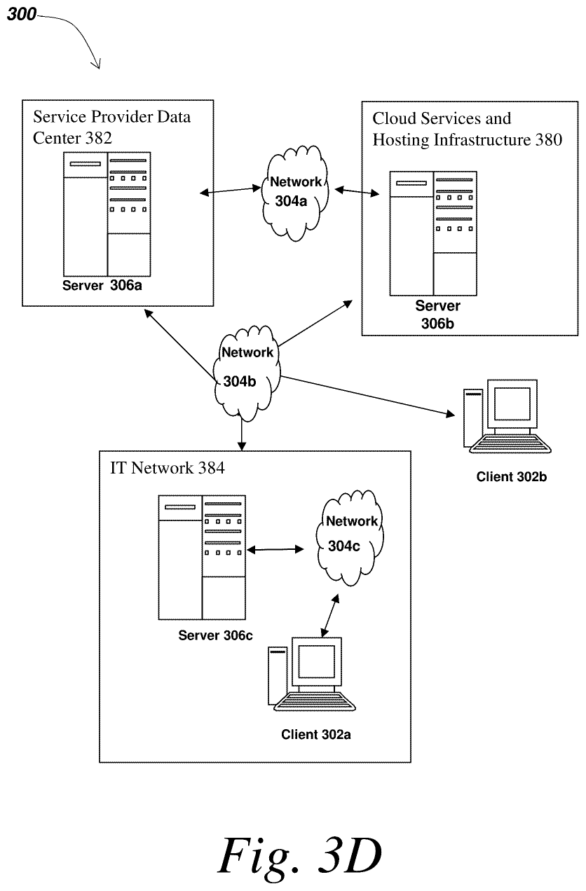

The computing device 106 may execute the data analysis engine 107. The computing device 106 may execute the access group generator 109. The computing device 106 may be a computing device as described in connection with FIGS. 3A-3D below.

The data analysis engine 107 may be provided as a software component. The data analysis engine 107 may be provided as a hardware component. The data analysis engine 107 may be in communication with the data event monitor 103. The computing device 106 may execute the data event monitor 103. A separate computing device 106b (not shown) may execute the data event monitor 103.

The access group generator 109 may be provided as a software component. The access group generator 109 may be provided as a hardware component. The access group generator 109 may be in communication with the data analysis engine 107. The computing device 106 may execute the access group generator 109. A separate computing device 106b (not shown) may execute the access group generator 109. The access group generator 109 may be an attribute-based access group generator and may therefore be referred to as an ABAG generator 109.

In one embodiment, a data object may be a document of any type, media file of any type, or other data object. In another embodiment, the data object is data in a format that natively supports encryption (e.g., PDF, compressed files, files generating using a word processing application such as, by way of example, the MICROSOFT WORD application). In still another embodiment, the data object is data in a format that does not natively support encryption. In some embodiments, the data object is sensitive data a data owner wishes to protect; for example, the data object may contain medical imagery data sets including raw data containing personally identifiable information or other sensitive data. In one of these embodiments, the data owner may be under legal or other regulatory constraints requiring the data owner to maintain control over the data and/or to prevent unauthorized access to the data.

The database 120 may be an ODBC-compliant database. For example, the database 120 may be provided as an ORACLE database, manufactured by Oracle Corporation of Redwood Shores, CA. In other embodiments, the database 120 can be a Microsoft ACCESS database or a Microsoft SQL server database, manufactured by Microsoft Corporation of Redmond, WA. In other embodiments, the database 120 can be a SQLite database distributed by Hwaci of Charlotte, NC, or a PostgreSQL database distributed by The PostgreSQL Global Development Group. In still other embodiments, the database 120 may be a custom-designed database based on an open source database, such as the MYSQL family of freely available database products distributed by Oracle Corporation of Redwood City, CA. In other embodiments, examples of databases include, without limitation, structured storage (e.g., NoSQL-type databases and BigTable databases), HBase databases distributed by The Apache Software Foundation of Forest Hill, MD, MongoDB databases distributed by 10Gen, Inc., of New York, NY, an AWS DynamoDB distributed by Amazon Web Services and Cassandra databases distributed by The Apache Software Foundation of Forest Hill, MD. In further embodiments, the database 120 may be any form or type of database.

Although, for ease of discussion, the data event monitor 103, the database 120, the computing device 206, data analysis engine 107, and the ABAG generator 109 are described in FIG. 1 as separate modules, it should be understood that this does not restrict the architecture to a particular implementation. For instance, these components may be encompassed by a single circuit or software function or, alternatively, distributed across a plurality of computing devices.

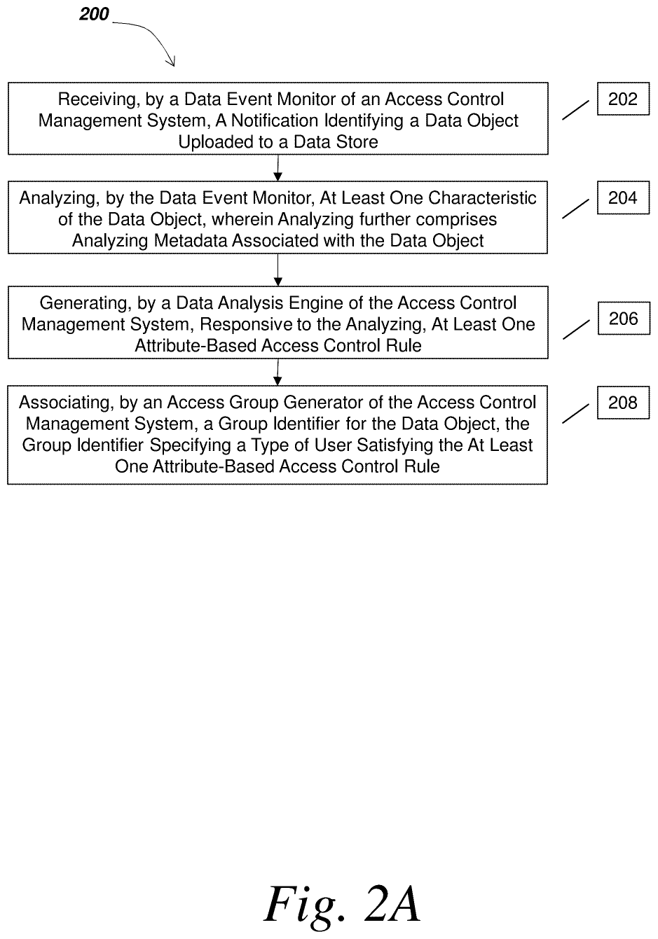

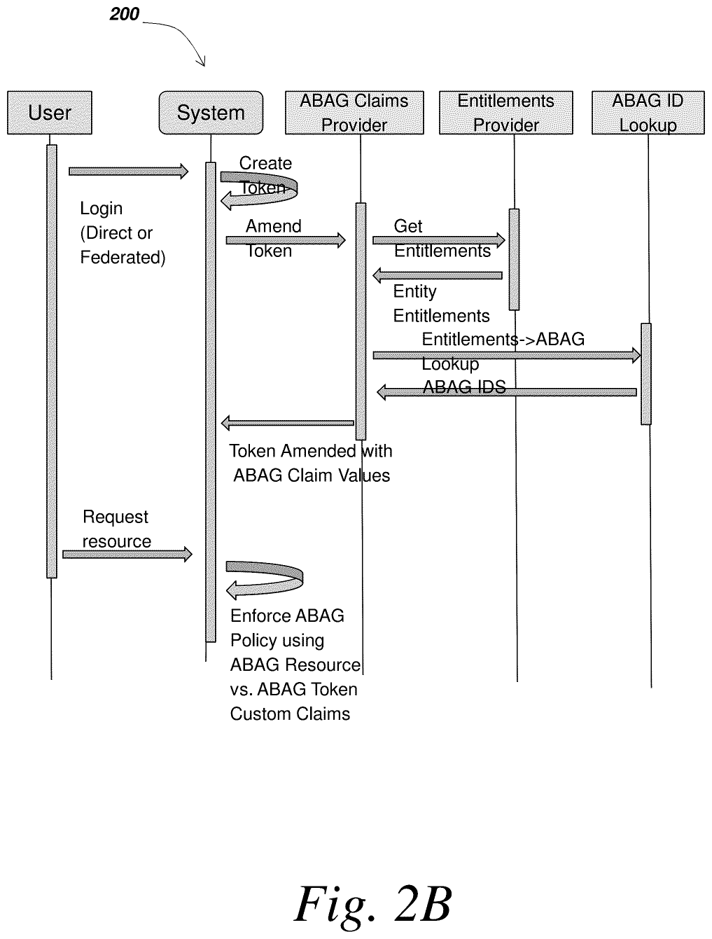

Referring now to FIG. 2, a flow diagram depicts one embodiment of a method 200 for attribute based group access control. In brief overview, the method 200 includes receiving, by a data event monitor of an access control management system, a notification identifying a data object uploaded to a data store (202). The method 200 includes analyzing, by the data event monitor, at least one characteristic of the data object, wherein analyzing further comprises analyzing metadata associated with the data object (204). The method 200 includes generating, by a data analysis engine of the access control management system, based upon the analyzing, at least one attribute-based access control rule (206). The method 200 includes associating, by an access group generator of the access control management system, a group identifier with the data object, the group identifier specifying a type of user satisfying the at least one attribute-based access control rule (208). The method 200 may include receiving a request for access to the data object by a user; determining that the user is of the specified type of user; and granting the requested access to the data object based upon the determination.

Referring now to FIG. 2 in greater detail, and in connection with FIG. 1, the method 200 includes receiving, by a data event monitor of an access control management system, a notification identifying a data object uploaded to a data store (202). The data event monitor 103 may receive a notification each time a data object is uploaded to the database 120. The data event monitor 103 may receive a notification upon completion of a process of uploading a data object to a data store, such as the database 120.

The method 200 includes analyzing, by the data event monitor, at least one characteristic of the data object, wherein analyzing further comprises analyzing metadata associated with the data object (204). The data event monitor 103 may identify at least one characteristic of the data object upon receiving the notification. The at least one characteristic may be an attribute of the data object used in generating an attribute-based access control (ABAC) rule. The data event monitor 103 may execute a tagging function (e.g., a tagging-pdp) to extract ABAC data attributes. The data event monitor 103 may extract one or more characteristics from metadata associated with the data object, including, without limitation, existing tags that may be used to derive attributes for use in generating ABAC rules. The data event monitor 103 may extract one or more characteristics from the data object itself; for example, and without limitation, the data event monitor 103 may extract the at least one characteristic from content of the data object via, e.g., optical character recognition, natural language processing, or other means for analyzing content in data objects. The at least one characteristic may include data specifying a type of classification of the data object; for example, the data object may be associated with data identifying a level of clearance (e.g., secret, top secret, etc.) a data user must have in order to view contents of the data object. As another example, the at least one characteristic may include data specifying a type of user to whom the data object may be released (e.g., based on user roles within an organization). The at least one characteristic may include data specifying an organization associated with the data object; this may be used in generating ABAC rules since different organizations may have rules regarding attributes of users (or their computing devices) and the system 100 may execute functionality to determine the rules of an organization based on the identification of an organization in the at least one characteristic. The at least one characteristic may include data specifying whether the data object includes protected health information (PHI), which may be associated with one or more ABAC rules.

The at least one characteristic may be considered to be a “long dwell” attribute, or a type of attribute-based access control attribute that is likely to remain the same over a period of time, including, for example, periods of times that include a plurality of user sessions. As a simple example, if a data object requires top secret clearance, the system 100 may determine that this requirement is unlikely to change over short periods of time. The at least one characteristic may be considered to be a “per session” attribute, or a type of ABAC attribute that is likely to remain the same for the duration of a user session but may change from one session to another. As a simple example, if a data object requires that a user access the data object over a secure network connection, the system 100 may determine that the user's connectivity may change from one session to another and therefore categorize this characteristic as one that should be associated with an ABAC rule that is checked for compliance each time the user logs in. The at least one characteristic may be considered to be a “real time” attribute or an attribute that is an event-based attribute and the system 100 may need to monitor for events (or be in communication with functionality for monitoring for events) for the duration of each session in which a user may access the data object.

The data event monitor 103 may transmit, to the data analysis engine 107, an identification of the data object. The data event monitor 103 may transmit, to the data analysis engine 107, an identification of at least one characteristic of the data object. The data event monitor 103 may transmit, to the data analysis engine 107, an identification of a storage location of the data object.

The method 200 includes generating, by a data analysis engine of the access control management system, based upon the analyzing, at least one attribute-based access control rule (206). The data analysis engine 107 may analyze the received identification of the at least one characteristic of the data object and generate the ABAC rule based upon the analysis. The data analysis engine 107 may translate the at least one characteristic into an ABAC rule. As a simple example, if a data object is associated with a characteristic that specifies users accessing the data object must have secret level clearance to access the data object, the data analysis engine 107 may generate an ABAC rule indicating that a user must be associated with an identifier of secret clearance or higher in order to be included in a group of users who may access the data object.

The method 200 includes associating, by an access group generator of the access control management system, a group identifier with the data object, the group identifier specifying a type of user satisfying the at least one attribute-based access control rule (208). The access group generator 109 may receive the ABAC rule from the data analysis engine 107. The access group generator 109 may compute a unique ABAG identifier to associate with the set of data attributes within the ABAC rule. The ABAG identifier may be a hash or other unique identifier. The ABAG identifier may be associated with a human-readable description of an identifier. The ABAG identifier may identify a type of user known to have an attribute (or known to use computing devices having attributes) that satisfy the requirements of the attribute based access control rule and may dynamically generate a group of such users who will be authorized to access the data object. For example, and without limitation, the access group generator 109 may associate an ABAG identifier with a user group and when a user logs in the access group generator 109 may determine whether the user has attributes that satisfy the requirements of the ABAC rule(s) and, if so, add the user to the group that has access to the data object.

The access group generator 109 may maintain a registry of ABAG identifiers. Prior to generating a new ABAG identifier for a new group of users, in some embodiments, the access group generator 109 may optionally determine whether a previously-generated ABAG identifier exists that would be substantially similar to the new ABAG identifier and, if so, the access group generator 109 may determine to re-use the previously generated ABAG identifier for the data object instead of associating a new ABAG identifier with the data object. As a simple example and without limitation, if the data event monitor 103 determines that a file has attributes A and B, and if the data analysis engine 107 receives an identification of attributes A and B and generates an attribute-based access control rule that governs which users may access the file, the access group generator 109 may generate an ABAG identifier based on information about attributes A and B (e.g., a hash of a value associated with the attributes) and then determine whether an existing ABAG identifier matches the newly generated ABAG identifier—in the case where the ABAG identifier is generated by hashing values associated with the attributes, if two ABAG identifiers (e.g., two hashes) are substantially similar, then they were necessarily generated with the same attributes and will be associated with the same ABAC rule. As a result, continuing with this example, the access group generator 109 may determine that the system 100 need not maintain both of the ABAG identifiers and may associate the previously-generated ABAG identifier with the file.

The system 100 may use the unique ABAG identifier to enforce the ABAC rule(s). For example, the system 100 may generate a new access control list object to associate with the ABAG identifier. The access control list (ACL) object may identify a group or a claim. The system 100 may associate the ACL object with the data object. The system 100 may associate the unique ABAG identifier to the data object.

The method 200 may include receiving a request for access to the data object by a user; determining that the user is of the specified type of user; and granting the requested access to the data object based upon the determination. The method 200 may include determining that the user is not of the specified type of user and denying the requested access. The system 100 may execute an access PDP to enforce the data policy for a given user's entitlements. By way of example, the system 100 may receive an indication that a user is logging into the system 100 and will be requesting access to one or more data objects in the database 120. Continuing with this example, the system 100 may extract data associated with the user, including (optionally) data associated with a computing device of the user and/or data associated with an organization of the user, and may analyze the extracted data to identify one or more ABAC-related attributes. Continuing with this example, if a user has seventeen ABAC-related attributes, the system 100 may determine which of those ABAC-related attributes are associated with which ABAG identifiers and may modify a user interface displayed to the user to display identifiers of one or more data objects in the database 120 which the user has authorization to access. If at a subsequent point in time, the same user logs out and then logs back in again but this time only has fifteen ABAC-related attributes, the system 100 may determine that the user no longer satisfies the requirements needed to be included in one or more ABAG groups and the system 100 will modify the user interface displayed to the user to display identifiers of a different set of data objects to which the user now has access. By way of example, the access group generator 109 may receive an identification of one or more attributes of the user and execute substantially the same process for generating a user attribute identifier as the access group generator 109 used to generate the ABAG identifier—if the user attribute identifier is substantially the same as an ABAG identifier, then the access group generator 109 may conclude that the user satisfies the requirements of the ABAG identifier. As an example, user custom claims may be ABAG encoded values inferred from the user's attributes and the user attributes may be retrieved from an entitlements provider, e.g., such that providing a user email address to the entitlements provider returns an enumeration of attributes and associated permissions, such as alice@example.org->[{“Attribute1”, “WRITE”}]. The system 100 may generate a token referred to as a current access token that represents the authenticated user; the system 100 may amend the access token claims to include ABAG claim values and the resulting ABAG-enriched access token may be used to enforced ABAC rules against ABAG-based resources, using a native access control functionality of the system 100 or of applications executing within the system 100.

In some embodiments, data objects are processable by applications that organize users into groups. For example, a word processing application that processes a data object may provide access control at a group level instead of at a data object level. In such embodiments, by generating groups of users who can access data objects, the methods and systems described herein provide attribute-based access control at a group level and in a manner that is compatible with applications that grant access at the group level. Instead of organizing users by teams or departments or other organizational entities, however, the methods and systems described herein allow for the dynamic creation of groups based on attributes of users and/or of users' computing devices, which provides for creation of more granular control than an application would otherwise allow; by doing so automatically (i.e., without requiring human input) and in real-time as data objects are added to group data stores, the methods and systems described herein provide functionality for creating and enforcing access control policies in attribute-based groups, providing a technological improvement over conventional access control approaches with the addition of a data event monitor that can communicate with the data analysis engine 107 and the ABAG generator 109.

Referring now to FIGS. 3A, 3B, 3C, and 3D, block diagrams depict additional detail regarding computing devices that may be modified to execute functionality for implementing the methods and systems described above.

Referring now to FIG. 3A, an embodiment of a network environment is depicted. In brief overview, the network environment comprises one or more clients 302a-302n (also generally referred to as local machine(s) 302, client(s) 102, client node(s) 302, client machine(s) 302, client computer(s) 302, client device(s) 302, computing device(s) 302, endpoint(s) 302, or endpoint node(s) 302) in communication with one or more remote machines 306a-306n (also generally referred to as server(s) 306, machine(s) 306, or computing device(s) 306) via one or more networks 304.

Although FIG. 3A shows a network 304 between the clients 302 and the remote machines 306, the clients 302 and the remote machines 306 may be on the same network 304. The network 304 can be a local area network (LAN), such as a company Intranet, a metropolitan area network (MAN), or a wide area network (WAN), such as the Internet or the World Wide Web. In other embodiments, there are multiple networks 304 between the clients 302 and the remote machines 306. In one of these embodiments, a network 304′ (not shown) may be a private network and a network 304 may be a public network. In another of these embodiments, a network 304 may be a private network and a network 304′ a public network. In still another embodiment, networks 304 and 304′ may both be private networks. In yet another embodiment, networks 304 and 304′ may both be public networks.

The network 304 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 504 may comprise a wireless link, such as an infrared channel or satellite band. The topology of the network 304 may be a bus, star, or ring network topology. The network 304 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 302 and a remote machine 306 (referred to generally as computing devices 300) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein.

In one embodiment, a computing device 306 provides functionality of a web server. In some embodiments, a web server 106 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, WA, the ORACLE IPLANET web server products provided by Oracle Corporation of Redwood Shores, CA, or the BEA WEBLOGIC products provided by BEA Systems of Santa Clara, CA.

In some embodiments, the system may include multiple, logically-grouped remote machines 306. In one of these embodiments, the logical group of remote machines may be referred to as a server farm 338. In another of these embodiments, the server farm 338 may be administered as a single entity.

FIGS. 3B and 3C depict block diagrams of a computing device 300 useful for practicing an embodiment of the client 302 or a remote machine 306. As shown in FIGS. 3B and 3C, each computing device 300 includes a central processing unit 321, and a main memory unit 322. As shown in FIG. 3B, a computing device 300 may include a storage device 328, an installation device 316, a network interface 318, an I/O controller 323, display devices 324a-n, a keyboard 326, a pointing device 327, such as a mouse, and one or more other I/O devices 330a-n. The storage device 328 may include, without limitation, an operating system and software. As shown in FIG. 3C, each computing device 300 may also include additional optional elements, such as a memory port 303, a bridge 370, one or more input/output devices 530a-n (generally referred to using reference numeral 330), and a cache memory 340 in communication with the central processing unit 321.

The central processing unit 321 is any logic circuitry that responds to and processes instructions fetched from the main memory unit 322. In many embodiments, the central processing unit 321 is provided by a microprocessor unit, such as: those manufactured by Intel Corporation of Mountain View, CA; those manufactured by Motorola Corporation of Schaumburg, IL; those manufactured by Transmeta Corporation of Santa Clara, CA; those manufactured by International Business Machines of White Plains, NY; or those manufactured by Advanced Micro Devices of Sunnyvale, CA. Other examples include SPARC processors, ARM processors, processors used to build UNIX/LINUX “white” boxes, and processors for mobile devices. The computing device 300 may be based on any of these processors, or any other processor capable of operating as described herein.

Main memory unit 322 may be one or more memory chips capable of storing data and allowing any storage location to be directly accessed by the microprocessor 321. The main memory unit 322 may be based on any available memory chips capable of operating as described herein. In the embodiment shown in FIG. 3B, the processor 321 communicates with main memory unit 322 via a system bus 350. FIG. 3C depicts an embodiment of a computing device 300 in which the processor communicates directly with main memory unit 322 via a memory port 303. FIG. 3C also depicts an embodiment in which the main processor 321 communicates directly with cache memory 340 via a secondary bus, sometimes referred to as a backside bus. In other embodiments, the main processor 321 communicates with cache memory 340 using the system bus 350.

In the embodiment shown in FIG. 3B, the processor 321 communicates with various I/O devices 330 via a local system bus 350. Various buses may be used to connect the central processing unit 321 to any of the I/O devices 330, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 324, the processor 321 may use an Advanced Graphics Port (AGP) to communicate with the display 324. FIG. 3C depicts an embodiment of a computer 300 in which the main processor 321 also communicates directly with an I/O device 330b via, for example, HYPERTRANSPORT, RAPIDIO, or INFINIBAND communications technology.

One or more of a wide variety of I/O devices 330a-n may be present in or connected to the computing device 300, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 323 as shown in FIG. 3B. Furthermore, an I/O device 330 may also provide storage and/or an installation device 316 for the computing device 300. In some embodiments, the computing device 300 may provide USB connections (not shown) to receive handheld USB storage devices such as the USB Flash Drive line of devices manufactured by Twintech Industry, Inc. of Los Alamitos, CA.

Referring still to FIG. 3B, the computing device 300 may support any suitable installation device 316, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 300 may provide functionality for installing software over a network 304. The computing device 300 may further comprise a storage device, such as one or more hard disk drives or redundant arrays of independent disks, for storing an operating system and other software. Alternatively, the computing device 300 may rely on memory chips for storage instead of hard disks.

Furthermore, the computing device 300 may include a network interface 318 to interface to the network 304 through a variety of connections including, but not limited to, standard telephone lines, LAN or WAN links (e.g., 802.11, T1, T3, 56 kb, X.25, SNA, DECNET, RDMA), broadband connections (e.g., ISDN, Frame Relay, ATM, Gigabit Ethernet, Ethernet-over-SONET), wireless connections, virtual private network (VPN) connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 300 communicates with other computing devices 300′ via any type and/or form of gateway or tunneling protocol such as GRE, VXLAN, IPIP, SIT, ip6tnl, VTI and VTI6, IP6GRE, FOU, GUE, GENEVE, ERSPAN, Secure Socket Layer (SSL) or Transport Layer Security (TLS). The network interface 318 may comprise a built-in network adapter, network interface card, PCMCIA network card, card bus network adapter, wireless network adapter, USB network adapter, modem, or any other device suitable for interfacing the computing device 300 to any type of network capable of communication and performing the operations described herein.

In further embodiments, an I/O device 330 may be a bridge between the system bus 350 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a Serial Plus bus, a SCI/LAMP bus, a Fibre Channel bus, or a Serial Attached small computer system interface bus.

A computing device 300 of the sort depicted in FIGS. 3B and 3C typically operates under the control of operating systems, which control scheduling of tasks and access to system resources. The computing device 300 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, WINDOWS VISTA, and WINDOWS 10 all of which are manufactured by Microsoft Corporation of Redmond, WA; MAC OS manufactured by Apple Inc. of Cupertino, CA; OS/2 manufactured by International Business Machines of Armonk, NY; Red Hat Enterprise Linux, a Linux-variant operating system distributed by Red Hat, Inc., of Raleigh, NC; Ubuntu, a freely-available operating system distributed by Canonical Ltd. of London, England; CentOS, a freely-available operating system distributed by the centos.org community; SUSE Linux, a freely-available operating system distributed by SUSE, or any type and/or form of a Unix operating system, among others.

The computing device 300 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 300 may have different processors, operating systems, and input devices consistent with the device.

Referring now to FIG. 3D, a block diagram depicts one embodiment of a system in which a plurality of networks provides hosting and delivery services. In brief overview, the system includes a cloud services and hosting infrastructure 380, a service provider data center 382, and an information technology (IT) network 384.

In one embodiment, the service provider data center 382 includes computing devices such as, without limitation, servers (including, for example, application servers, file servers, databases, and backup servers), routers, switches, and telecommunications equipment. In another embodiment, the cloud services and hosting infrastructure 380 provides access to, without limitation, storage systems, databases, application servers, desktop servers, directory services, web servers, as well as services for accessing remotely located hardware and software platforms. In still other embodiments, the cloud services and hosting infrastructure 380 includes a data center 382. In other embodiments, however, the cloud services and hosting infrastructure 380 relies on services provided by a third-party data center 382. In some embodiments, the IT network 304c may provide local services, such as mail services and web services. In other embodiments, the IT network 304c may provide local versions of remotely located services, such as locally-cached versions of remotely-located print servers, databases, application servers, desktop servers, directory services, and web servers. In further embodiments, additional servers may reside in the cloud services and hosting infrastructure 380, the service provider data center 382, or other networks altogether, such as those provided by third-party service providers including, without limitation, infrastructure service providers, application service providers, platform service providers, tools service providers, and desktop service providers.

In one embodiment, a user of a client 302a-b accesses services provided by a remotely located server 306a. For instance, an administrator of an enterprise IT network 384 may determine that a user of the client 302a will access an application executing on a virtual machine executing on a remote server 306a. As another example, an individual user of a client 302b may use a resource provided to consumers by a remotely located server 306b (such as email, fax, voice or other communications service, data backup services, or other service).

As depicted in FIG. 3D, the service provider data center 382 and the cloud services and hosting infrastructure 380 are remotely located from an individual or organization supported by the data center 382 and the cloud services and hosting infrastructure 380; for example, the data center 382 may reside on a first network 304a and the cloud services and hosting infrastructure 380 may reside on a second network 504b, while the IT network 384 is a separate, third network 304c. In other embodiments, the service provider data center 382 and the cloud services and hosting infrastructure 380 reside on a first network 304a and the IT network 384 is a separate, second network 304c. In still other embodiments, the cloud services and hosting infrastructure 380 resides on a first network 504a while the service provider data center 382 and the IT network 384 form a second network 304c. Although FIG. 3D depicts only one sever 306a, one server 306b, one server 306c, two clients 302a-b, and three networks 304, it should be understood that the system may provide multiple ones of any or each of those components. The servers 306, clients 302, and networks 304 may be provided as described above in connection with FIGS. 3A-3C.

Therefore, in some embodiments, an IT infrastructure may extend from a first network—such as a network owned and managed by an individual or an enterprise—into a second network, which may be owned or managed by a separate entity than the entity owning or managing the first network. Resources provided by the second network may be said to be “in a cloud.” Cloud-resident elements may include, without limitation, storage devices, servers, databases, computing environments (including virtual machines, servers, and desktops), and applications. For example, the IT network 384 may use a remotely located service provider data center 382 to store servers (including, for example, application servers, file servers, databases, and backup servers), routers, switches, and telecommunications equipment. The service provider data center 382 may be owned and managed by the IT network 384 or a third-party service provider (including for example, a cloud services and hosting infrastructure provider) may provide access to a separate data center 382.

In some embodiments, one or more networks providing computing infrastructure on behalf of customers is referred to a cloud. In one of these embodiments, a system in which users of a first network access at least a second network including a pool of abstracted, scalable, and managed computing resources capable of hosting resources may be referred to as a cloud computing environment. In another of these embodiments, resources may include, without limitation, virtualization technology, data center resources, applications, and management tools. In some embodiments, Internet-based applications (which may be provided via a “software-as-a-service” model) may be referred to as cloud-based resources. In other embodiments, networks that provide users with computing resources, such as remote servers, virtual machines, or blades on blade servers, may be referred to as compute clouds or “infrastructure-as-a-service” providers. In still other embodiments, networks that provide storage resources, such as storage area networks, may be referred to as storage clouds. In further embodiments, a resource may be cached in a local network and stored in a cloud.

In some embodiments, some or all of a plurality of remote machines 106 may be leased or rented from third-party companies such as, by way of example and without limitation, Amazon Web Services LLC of Seattle, WA; Rackspace US, Inc. of San Antonio, TX; Microsoft Corporation of Redmond, WA; and Google Inc. of Mountain View, CA. In other embodiments, all the hosts 306 are owned and managed by third-party companies including, without limitation, Amazon Web Services LLC, Rackspace US, Inc., Microsoft, and Google.

It should be understood that the systems described above may provide multiple ones of any or each of those components and these components may be provided on either a standalone machine or, in some embodiments, on multiple machines in a distributed system. The phrases ‘in one embodiment’, ‘in another embodiment’, and the like, generally mean the particular feature, structure, step, or characteristic following the phrase is included in at least one embodiment of the present disclosure and may be included in more than one embodiment of the present disclosure. Such phrases may, but do not necessarily, refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAS (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

In some embodiments, the system 100 includes non-transitory, computer-readable medium comprising computer program instructions tangibly stored on the non-transitory computer-readable medium, wherein the instructions are executable by at least one processor to perform each of the steps described above in connection with FIG. 2A-2B.

The terms “A or B”, “at least one of A or/and B”, “at least one of A and B”, “at least one of A or B”, or “one or more of A or/and B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

Although terms such as “optimize” and “optimal” may be used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

Having described certain embodiments of methods and systems for attribute based group access control, it will be apparent to one of skill in the art that other embodiments incorporating the concepts of the disclosure may be used. Therefore, the disclosure should not be limited to certain embodiments, but rather should only be limited by the spirit and scope of the following claims.

What is claimed is:

1. A method, performed by at least one computer processor executing computer program instructions stored on at least one non-transitory computer-readable medium, for attribute based group access control, comprising:
receiving, by a data event monitor of an access control management system, a notification identifying a data object uploaded to a data store;
analyzing, by the data event monitor, at least one characteristic of the data object, wherein analyzing further comprises analyzing metadata associated with the data object;
generating, by a data analysis engine of the access control management system, responsive to the analyzing, at least one attribute-based access control rule; and
associating, by an access group generator of the access control management system, a group identifier with the data object, the group identifier specifying a type of user satisfying the at least one attribute-based access control rule.

2. The method of claim 1 wherein receiving, by the data event monitor, the notification further comprises receiving, by the data event monitor, the notification upon completion of process of uploading the data object to the data store.

3. The method of claim 1 further comprising transmitting, by the data event monitor, to the data analysis engine, an identification of the data object.

4. The method of claim 1, wherein analyzing further comprises executing a tagging function to extract at least one data attribute from the metadata.

5. The method of claim 4, wherein generating further comprises generating the at least one attribute-based access control rule using the extracted at least one data attribute.

6. The method of claim 1, wherein generating further comprises translating, by the data analysis engine, the at least one characteristic into an attribute based access control rule.
